(19) United States
(12) Patent Application Publication
(10) Pub. No.: US 2007/0283743 A1
(43) Pub. Date: Dec. 13, 2007

(54) Calibration Pipette

(76) Inventors: Juha Telimaa, Jarvenpaa (FI); Mikael Lind, Helsinki (FI)

Correspondence Address: NIXON & VANDERHYE, PC, 901 NORTH GLEBE ROAD, 11TH FLOOR, ARLINGTON, VA, 22203, US

(21) Appl. No.: 10/590,382

(22) PCT Filed: Feb. 24, 2005
(86) PCT No.: PCT/FI05/00116

§ 371 Date: Jun. 20, 2007

(30) Foreign Application Priority Data
Feb. 25, 2004 (FI) 20040292

(51) Int. Cl. G01F 25/00; B01L 3/02

(52) U.S. Cl. 73/1.74

(57) ABSTRACT

The invention concerns a calibration pipette comprising an actuated electronic dis-play (3) and a calibration function. The calibration function is such that at least one real volume obtained with an indicated volume is input via a user interface into the control system and that the control system calculates calibration settings and stores them in a memory, by means of which settings the stroke length of the pis-ton or the volume indicated on the display is corrected so that the volume indi-cated on the display equals the real dosing volume. The calibration resolution is less than 0.1%, preferably less than 0.05% and most preferably less than 0.01%.

### FIELD OF TECHNOLOGY

The invention relates to a pipette intended for use in the dosage of liquids and comprising an electronic system for displaying the pipetting volume and a user interface allowing input of calibration data into the operating system. The invention relates specifically to this calibration function.

### TECHNOLOGICAL BACKGROUND

Pipettes used for liquid dosage in laboratories comprise a piston movable in a cylinder for aspiration of liquid into a tip container connected with the cylinder. There are also electronic pipettes whose piston is actuated by means of an electric motor and an associated control system. However, there are also electronic pipettes whose pistons are actuated by manual force and which comprise an electronic display for indicating for instance the pipetting volume. Electronic pipettes have a user interface for selection of i.a. the desired pipetting function, setting of the volume of a pipette with variable volume, and for giving commands for performing operations. The user interface has the necessary switches for input of the necessary settings and functions. The user interface is connected with a display, by means of which i.a. the volume can be displayed.

Pipettes usually have a calibration function allowing the piston stroke or the volume indicated on the display to be set so that the dosed liquid volume equals the indicated volume with maximal accuracy. In the practice, calibration comprises weighing of the weight of the liquid amount dosed by the pipette with an indicated volume. The liquid is usually distilled water and the calibration is performed at room temperature (20-25° C.). Usually weighing is repeatedly carried out and the mean value of the results of the weighing operations is calculated. Calibration is generally performed assuming that the set volume and the dosing volume are linearly interdependent,
dosing volume=constant 1·set volume+constant 2 (I)

Constant 1 is the angular coefficient of a straight line and constant 2 is a correction factor. Calibration is usually performed in the manufacturing step, being subsequently repeated whenever necessary. Electrically operated pipettes usually comprise a step motor, the number of steps determining the piston stroke and thus also the volume.

Calibration is preferably performed by weighing the real liquid amount obtained with two volume settings, allowing calculation of the constants corresponding to the formula above. Such prior art pipettes require input of precalculated constant values, allowing the user to change the two constants, i.e. to perform dual-point calibration, when recalibrating the pipette. Such a pipette is i.a. Finnpipette® Bio-Control (manufacturer Thermo Electron, Finland).

However, there is also a known pipette, Transferpipette® Easy Calibration™ (manufacturer Brand GmbH, Germany), in which the angular coefficient of the straight line (constant 1) mentioned above has been preset in the control system and cannot be changed by the user. The user may recalibrate the pipette at one single point. However, in this case, the input relates to the real volume obtained directly with one setting, the control system calculating and changing the value of the correction coefficient above (constant 2). In this pipette, the real volume is entered with the same accuracy as the one with which the set volume is indicated. This implies very rough calibration resolution. Thus, for instance, the volume of a 200 μl pipette is indicated with a precision of 0.2 μl, implying optimal resolution of 0.1%.

### SUMMARY OF THE INVENTION

An electronic calibration pipette, its control system and a method for calibrating the pipette have now been invented. The dependent claims describe some embodiments of the invention.

According to the first aspect of the invention, a measured volume obtained with at least one volume setting is input into the control system with a resolution less than 0.1%, preferably less than 0.05% and most preferably less than 0.01%. The control system calculates the corresponding calibration settings on the input values and stores them in a memory. In this manner, the person who carries out calibration does not have to calculate the settings, thus both reducing the work amount and eliminating the risk of calculation errors. With a low calibration resolution, the dosage precision is accordingly higher. The dosage precision over the entire volume range is further enhanced when the calibration is performed using two or more volumes.

### DRAWINGS

The accompanying drawings pertain to the written description of the invention and relate to the following detailed description of the invention. In the drawings

FIG. 1 shows a pipette of the invention

FIG. 2 shows as chart the operation of the pipette

FIG. 3 shows single-point calibration of the pipette step by step

FIG. 4 shows dual-point calibration of the pipette step by step.

### DETAILED DESCRIPTION OF THE INVENTION

The pipette of the invention comprises an electronic volume display and an associated control system and user interface. When the pipette is calibrated, (at least one) real volume obtained by measurement and corresponding to the displayed volume is input into the control system via the user interface. The control system calculates and subsequently stores the calibration settings, and during subsequent dosage, the piston stroke or the displayed volume is corrected in accordance with these settings so that the dosing volume equals the displayed volume with maximum accuracy. In this manner, the person who carries out calibration does not have to calculate the settings, thus both reducing the amount of work and eliminating the risk of calculating errors. The pipette is preferably calibrated with several, especially two volumes. The display is preferably a “full-graphics display”.

The pipette is preferably such that the set volume can be changed, but the invention is also applicable to pipettes with constant volume. The pipette is preferably also such that its piston is actuated by means of a motor, such as an electric motor. However, the invention is applicable also to pipettes whose piston is actuated by manual force but which comprise an electronic volume display.

Calculation of calibration settings can be performed assuming specifically that the set volume and the dosing volume are in linear interdependence. When the piston is actuated by means of a step motor, the number of steps is directly proportional to the volume.

The necessary calibration settings can be affected by the following factors in particular:
Liquid properties, especially density, viscosity and volatility.
Perating conditions, such as temperature and pressure.
Pipetting function to be used, such as direct or reverse pipetting. Direct pipetting involves direct aspiration of a desired volume, while reverse pipetting involves aspiration of a volume greater than the desired one, with the desired volume being subsequently discharged.
Piston drive speed.
Manner of treatment, such as whether to sweep a surface with the tip when the liquid is dispensed.
The user's individual habits, i.e. “handwriting”, such as e.g. pipette position (angle and depth) relative to the liquid surface during liquid aspiration.

According to a first aspect of the invention, the measured volume obtained with at least one volume setting is input into the pipette control system with a calibration resolution less than 0.1%. The volume is preferably entered with a resolution less than 0.05% and still more preferably less than 0.01%. In this context, resolution implies the precision of the measured volume to be fed relative to the maximum dosing volume of the pipette. When the calibration comprises input of one single volume, assuming a linear dependence, the correction is preferably calculated in the correction coefficient alone (i.e. constant 2 of formula I). The angular coefficient (constant 1) is not changed but has been preset (to a value of 1 in the practice). The calibration volume is preferably selected in the centre of the dosage range to be used. With a low calibration resolution, the precision is accordingly higher.

According to a second aspect of the invention measured volumes obtained with several, especially two settings are input into the control system. Based on the input volumes, the control system calculates the calibration settings, thus, for instance, assuming a linear dependence, the angular coefficient (constant 1) and the correction coefficient (constant 2). When two calibration volumes are used, one volume is preferably selected at the top of the volume range and the other at its bottom. Calibration performed with several volumes yields higher precision over the entire volume range. The volumes are preferably entered with a calibration resolution less than 0.1%.

According to a third aspect of the invention, a plurality of calibration settings can be stored in the control system, with the settings corresponding to the current pipetting function being subsequently employed. This allows the same pipette to be used with high precision for most varying pipetting purposes without requiring recalibration of the pipette each time. When the user switches to another pipetting function, he just selects the settings corresponding to the new function from among the stored calibration settings. The volumes are preferably fed with a calibration resolution less than 0.1%. Measured volumes obtained with several, especially two settings are preferably input in the control system.

The control system has a function for calculating by means of the input volumes the calibration settings by which the piston stroke length or the displayed volume are corrected so that the dosed volume equals the indicated volume. Usually the calibration settings are used for correcting the piston stroke length. In a pipette equipped with a step motor, the number of steps of the motor is then appropriately corrected.

In other respects, the pipette mechanism and the control system can operate on the same principles as those described in FI 96007 (corresponding to EP 576967).

A number of embodiments of the invention are exemplified below.

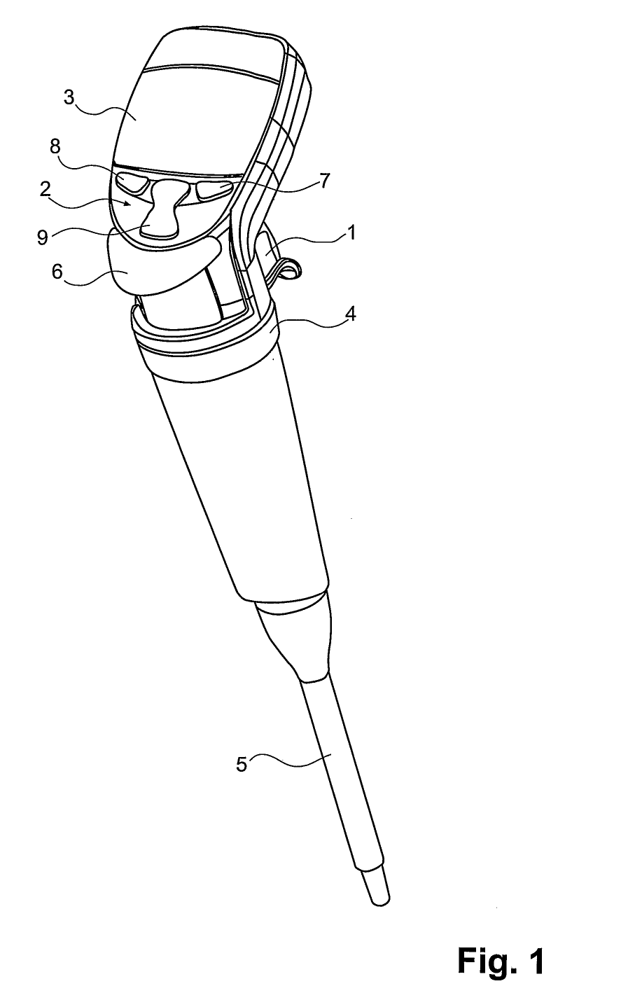

FIG. 1 shows a pipette driven with an electric motor. Its user interface of the control system comprises an operating switch 1, a setting keyboard 2 and a display 3.

The operating switch 1 has been disposed in a wheel 4 rotatable relative to the body. This allows the user to adjust the position of the operating switch. A push-button 6 of a tip removal sleeve 5 is provided in the pipette body on the opposite side of the switch. The tip is removed by manual force. It has preferably been relieved by a lever mechanism, especially such as the tip remover is urged to move by means of a wheel relative to the pipette body, as described in FI 92374 (corresponding e.g. to EP 566939).

The display 3 is disposed at the top of the pipette, in a position upwardly oblique away from the push-button 6 of the tip removal sleeve on the upper surface of a projection. A power source is provided within the projection. The setting keyboard 2 is disposed on the upper surface of the projection, at its end on the side of the body. The display shows necessary information about the settings used each time, such as e.g. the pipette volume and function in use and the current function step. The display also shows different menus depending on the situation, allowing the settings to be changed.

The pipette settings can be changed by means of the setting keyboard 2. The setting keys are: a right-hand selection key 7, a left-hand selection key 8 and a bifunctional scanning key (arrow keys) 9. The current is switched on by depression of any key. Depending on the setting step, the selection keys allow the user to move forwards or backwards in a menu hierarchy or to start using a selected function. Depending on the setting step, the scanning key allows the user to move to an option on the display or to change characters on the display (such as digits or writing). The selection function enables the user to move to the desired location in the menu and to confirm it by means of the selection keys. The change function scans a character string, of which the desired character is selected. The characters may act on a setting of the function (e.g. volume, piston stroke speed), or they may be confined to giving information.

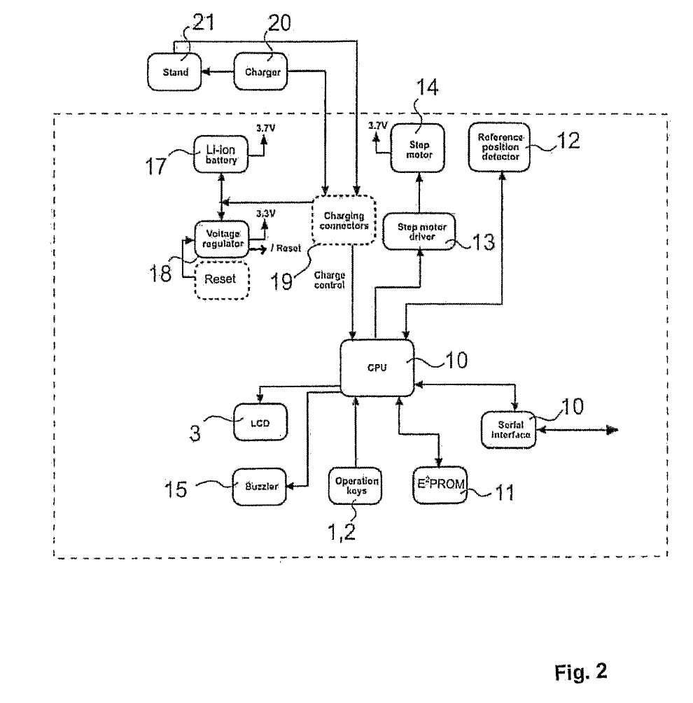

FIG. 2 shows the pipette functions schematically. The core of the control system is a central processing unit (CPU) 10 connected with a memory 11. The CPU is used by means of function keys, i.e. the operating switch 1 and the setting keyboard 2. The CPU is informed of the piston position by a position sensor 12. The CPU gives the commands needed for actuating the piston to a driver 13, which controls a step motor 14. The functions are indicated on the display (liquid crystal display LCD) 3. Some functions are indicated with acoustic signals by means of a buzzer 15. In addition, the CPU is connected to a serial interface 16 allowing data input into or output from the CPU. A chargeable 3.7 V Li ion battery 17 acts as the voltage source. The battery comprises a voltage control and reactivating circuit 18. The battery is charged over terminals 19 using a charger 20 in a stand 21. The charging is also controlled by the CPU.

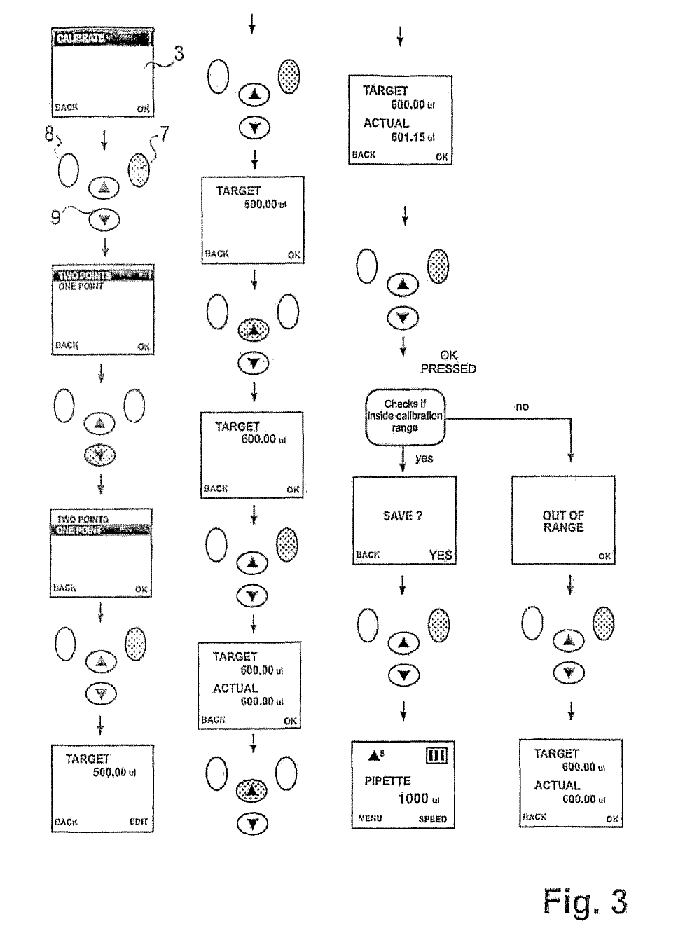

FIG. 3 exemplifies the steps of single-point calibration with a pipette having a volume range of 100-1,000 μl. The calibration mode is scanned on the display 3 using scan key 9 (arrow keys), and then the following menu is opened by using the right-hand selection key 7. This menu shows that in this case the pipette has been previously calibrated at two points. The user then selects single-point calibration and proceeds to the volume setting menu. The display indicates the target volume 500.00 μl. By pressing the enter key, the user may change the volume with the arrow keys. When the desired new target volume (600.00 μl) has been obtained, the user confirms it, and then the real feed volume obtained by measurement appears on the display and can now be changed with the scan key. (The real volume is obtained by weighing e.g. ten dosages and calculating the mean value of these). The user may confirm the changed volume, or he may return to the menu for entering the real volume. When the volume is confirmed, the system checks whether the calibration coefficients obtained are within acceptable limits, and if this is the case, it requests confirmation of the calibration, and then the calibration is stored. Unless the coefficient is within the acceptable limits, the system returns to the input of real volumes. The calibration setting is taken into account in the determination of the piston movement.

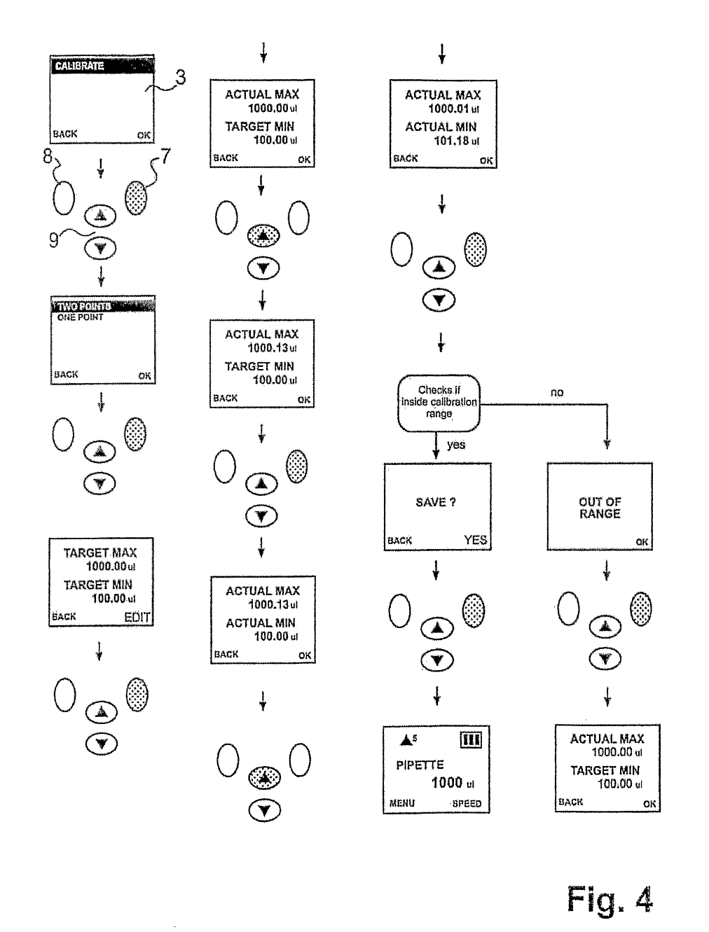

FIG. 4 exemplifies the steps of dual-point calibration. The user scans the calibration mode on the display 3 using the scan key 9 (arrow keys), and then he opens the following menu by means of the right-hand selection key 7. This menu shows that the pipette has in this case been previously calibrated at two points. By confirming this, the user opens the volume setting menu. The display indicates two target volumes: maximum 1,000.00 μl and minimum 100.00 μl. These can be changed if desired. When the user confirms them, he opens the menu for entering the real minimum volume obtained by the minimum target volume and then the menu for entering the real volume obtained with the maximum target volume. Then the system checks whether these calibration coefficients are within acceptable limits, and if this is the case, it requests confirmation of the calibration. Unless the coefficients are within the acceptable limits, the system resumes the input of real volumes.

When the real volume is entered as above with a precision of 0.01 μl, the calibration resolution corresponding to the minimum volume (100 μl) is thus 0.01%.

1-9. (canceled)

10. A calibration pipette comprising
a piston in a cylinder actuated by a motor and means for moving the piston over a distance such that a given liquid dosing volume is aspirated into or dispensed out of the pipette,
a control system,
a user interface (1, 2)
an electronic display (3), in which the dosing volume is indicated, and
a calibration function,
characterised in that
the calibration function is such that at least one real volume obtained with an indicated volume is input via the user interface into the control system and that the control system calculates calibration settings based on the input and stores them in a memory, by means of which settings the stroke length of the piston or the volume indicated on the display is corrected so that the volume indicated on the display equals the real dosing volume, and that
the calibration resolution is less than 0.1%, preferably less than 0.05% and most preferably less than 0.01%.

11. A pipette as defined in claim 10, in which the control system corrects the stroke length of the piston by means of the calibration settings.

12. A pipette as defined in claim 10, comprising a motor (14) for actuating the piston.

13. A pipette as defined in claim 10, in which the dosing volume is adjustable.

14. A pipette as defined in claim 13, in which the calibration function comprises input of the real volumes obtained with at least and preferably two indicated volumes.

15. A pipette as defined in claim 14, in which the control system calculates the calibration settings assuming that the real volume is in linear dependence with the set volume.

16. A pipette as defined in claim 10, in which the control system is such that allows storage of a plurality of calibration settings in parallel, so that the settings corresponding to the current pipetting function can be selected for use each time.

17. A system for controlling a calibration pipette, the pipette comprising
a piston actuated in a cylinder and a motor for actuating the piston over a distance such that a given liquid dosing volume is aspirated or dispensed out of the
pipette,
a user interface (1, 2),
an electronic display (3) in which the dosing volume is indicated, and
a calibration function,
characterised in that
the calibration function is such that real at least one volume obtained with indicated volume is input over the user interface into the control system and that the control system calculates calibration settings based on the input and stores them in a memory, by means of which settings the stroke length of the piston or the vol-ume indicated on the display is corrected so that the volume indicated on the dis-play equals the real dosing volume, and that
the calibration resolution is less than 0.1%, preferably less than 0.05% and most preferably less than 0.01%.

18. A method for calibrating a pipette, the pipette comprising
a piston actuated in a cylinder, a motor for actuating the piston over a distance such that a given liquid dosing volume is aspirated or dispensed out of the pipette, and means for changing the dosing volume,
a control system,
a user interface (1, 2),
an electronic display (3), in which the dosing volume is indicated
characterised in that
the real volumes obtained with at least two indicated volumes are input via the user interface (1, 2) into the control system, the control system being allowed to calculate calibration settings on these real volumes and to store them in a memory, by means of which calibration settings the control system corrects the stroke length of the piston or the volume indicated on the display so that the volume indicated on the display equals the real dosing volume, and that
the calibration resolution is less than 0.1%, preferably less than 0.05% and most advantageously less than 0.01%.
